(19) United States
(12) Patent Application Publication
(10) Pub. No.: US 2025/0253939 A1
(43) Pub. Date: Aug. 7, 2025

(54) SYSTEM AND METHODS FOR REGULATORY-AWARE ACCESS TO NETWORK RESOURCES OVER SATELLITES

(71) Applicant: Telefonaktiebolaget LM Ericsson (publ), Stockholm (SE)

(72) Inventors: Petri LAARI, Espoo (FI); Helka-Liina MÄÄTTÄNEN, Espoo (FI); Ari KERÄNEN, Helsinki (FI)

(21) Appl. No.: 18/686,408

(22) PCT Filed: Aug. 26, 2021
(86) PCT No.: PCT/SE2021/050832

§ 371 Date: Feb. 26, 2024

(51) Int. Cl. H04B 7/185

(52) U.S. Cl. CPC H04B 7/18565; H04B 7/18541; H04B 7/18554

(57) ABSTRACT

A method is provided by a Lightweight Machine to Machine (LwM2M) server for providing regulatory aware access to at least one network resource. The method includes obtaining information associated with a wireless device. The information includes a location of the wireless device. The LwM2M server transmits, to at least one device for determining whether to allow the wireless device to access the network resource, an object that includes the information including the location of the wireless device and at least one location-specific policy restriction associated with a satellite serving the location of the wireless device.

### TECHNICAL FIELD

The present disclosure relates, in general, to wireless communications and, more particularly, systems and methods for regulatory-aware access to network resources over satellites.

### BACKGROUND

The current 5^{th} Generation Radio Access Network RAN (NG-RAN) architecture is depicted and described in 3GPP TS 38.401v15.4.0 and illustrated in FIG. 1.

The NG-RAN consists of a set of gNodeBs (gNBs) connected to the 5^{th} Generation Core (5GC) through the NG interface. An gNB can support Frequency Division Duplex (FDD) mode, Time Division Duplex (TDD) mode or dual mode operation. gNBs can be interconnected through the Xn interface. A gNB may consist of a Central Unit (gNB-CU) and Distributed Units (gNB-DUs). A gNB-CU and a gNB-DU are connected via F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (i.e., NG, Xn, F1), the related TNL protocol and the functionality are specified. The TNL provides services for user plane transport and signaling transport.

A gNB may also be connected to an Long Term Evolution (LTE) eNodeB (eNB) via the X2 interface. Another architectural option is that where an LTE eNB connected to the Evolved Packet Core (EPC) network is connected over the X2 interface with a so called nr-gNB. The latter is a gNB not connected directly to a CN and connected via X2 to an eNB for the sole purpose of performing dual connectivity. The architecture in FIG. 1 can be expanded by spitting the gNB-CU into two entities. A first entity may correspond to the User Plane (gNB-CU-UP), which serves the user plane and hosts the Packet Data Convergence Protocol (PDCP). The second entity may correspond to the Control Plane (gNB-CU-CP), which serves the control plane and hosts the PDCP and Radio Resource Control (RRC) protocol. For completeness it should be said that a gNB-DU hosts the Radio Link Control (RLC), Medium Access Control (MAC) and Physical Layer (PHY) protocols.

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services. To benefit from the strong mobile ecosystem and economy of scale, adapting the terrestrial wireless access technologies including LTE and NR for satellite networks is drawing significant interest. For example, 3GPP completed an initial study in Release 15 on adapting NR to support non-terrestrial networks (mainly satellite networks). See, 3GPP TR 38.811, Study on New Radio (NR) to support non-terrestrial networks. This initial study focused on the channel model for the non-terrestrial networks, defining deployment scenarios, and identifying the key potential impacts. 3GPP is conducting a follow-up study item in Release 16 on solutions evaluation for NR to support non-terrestrial networks. See, RP-181370, Study on solutions evaluation for NR to support non-terrestrial networks.

As another example, 3GPP performed a study in 3GPP Radio Access Network (RAN) and Satellite Access (SA) groups on how satellite access can be included into the 5G System. The technical report from the 3GPP RAN is captured in 3GPP TR 38.821 and covers radio related work on how New Radio (NR) can be adjusted to work over satellite links, i.e. with base station onboard the satellite, or with a base station on the ground but with a “bend pipe” radio link via the satellite and back to earth.

A non-terrestrial network refers to a network, or segment of networks using RF resources on board a satellite (or UAS platform). A typical non-terrestrial network usually includes the following components:
Gateway that connects satellite network to core network
Satellite that refers to a space-borne platform
Terminal that refers to user equipment
Feeder link that refers to the link between a gateway and a satellite
Service link that refers to the link between a satellite and a terminal

FIG. 2 illustrates a typical scenario of a non-terrestrial network providing access to user equipment. Specifically, a Satellite or UAS platform transmits to and receives from one or more User Equipments (UEs) that are within the beam coverage within the field of view of the satellite. The satellite and UEs communicate over service links. The Satellite also communicates over a feeder link with a gateway that provides access to network resources provided by a data network. The link from gateway to terminal is also often called forward link, and the link from terminal to gateway is also often called return link or access link. Depending on the functionality of the satellite in the system, there are two transponder options:
Bent pipe transponder (also referred to as transparent satellite or transparent payload): satellite forwards the received signal back to the earth with only amplification and a shift from uplink frequency to downlink frequency.
Regenerative transponder (also referred to as regenerative satellite or regenerative payload): satellite includes on-board processing to demodulate and decode the received signal and regenerate the signal before sending it back to the earth.

FIGS. 3A-3C illustrate a few example configurations of non-terrestrial networks. Specifically, FIG. 3A illustrates the UE communicating with the satellite that is a radio frequency remote unit of the NR-Uu interface. The radio frequency remote unit, in turn, communicates with a remote radio unit (RRU) and gNodeB (gNB) over a NR-Uu interface. The gNB communicates with a 5^{th} Generation Core Network over the N1, N2, or N3 interface, which provides access to the data network via the N6 interface. FIG. 3B illustrates a similar configuration except a portion of gNB functionality is placed on the satellite. Specifically, a gNB distributed unit (gNB-DU) is placed on the satellite and communicates with a ground-based gNB Central Unit (gNB-CU) over F1 over Satellite Radio Interface (SRI). FIG. 3C illustrates another configuration where all of the gNB functionality is placed on or performed by the satellite, which communicates with the RRU via NG over SRI.

Depending on the orbit altitude, a satellite may be categorized as low earth orbit (LEO), medium earth orbit (MEO), or geostationary (GEO) satellite:
LEO: typical heights ranging from 250-1,500 km, with orbital periods ranging from 90-130 minutes.
MEO: typical heights ranging from 5,000-25,000 km, with orbital periods ranging from 2-14 hours.
GEO: height at about 35,786 km, with an orbital period of 24 hours.

A communication satellite typically generates several beams over a given area. The footprint of a beam is usually in an elliptic shape, which has been traditionally considered as a cell, but cells consisting of the coverage footprint of multiple beams are excluded. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

One problem is how to handle the large cell sizes of a satellite. A cell is built up by either a single satellite beam, or by multiple satellite beams. This means that the satellite cell will have at least the same size as a satellite beam. Typical beam coverage (footprint size) for different types of NTN platforms is shown in Table 1.

TABLE 1

| | | | | Typical | |
|---|---|---|---|---|---|
| | | | | beam | |
| | | | | footprint | |
| Platforms | Altitude range | | Orbit | size | |
| Low-Earth Orbit | 300-1500 | km | Circular around the | 100-1000 | km |
| (LEO) satellite | | | earth | | |
| Medium-Earth | 7000-25000 | km | | 100-1000 | km |
| Orbit (MEO) | | | | | |
| satellite | | | | | |
| Geostationary | 35 786 | km | notional station | 200-3500 | km |
| Earth Orbit | | | keeping position fixed | | |
| (GEO) satellite | | | in terms of elevation/ | | |
| UAS platform | 8-50 km (20 km | | azimuth with respect | 5-200 | km |
| (including | for HAPS) | | to a given earth point | | |
| HAPS) | | | | | |
| High Elliptical | 400-50000 | km | Elliptical around the | 200-3500 | km |
| Orbit (HEO) | | | earth | | |
| satellite | | | | | |

This is much larger than the typical cell size of terrestrial networks, which may range from a few tens to a few thousands of meters. Additionally, the lower orbit satellites move with respect to Earth and if the beams are not fixed to an Earth location (one of the 3GPP assumptions), the beam also sweeps across the earth. For the option where gNB is on board of the satellite, as shown in FIGS. 2B and 2C, the gNB also sweep across the Earth.

FIG. 4 illustrates a satellite as it sweeps across the earth over a sample of time. In the depicted example, the satellite's coverage area corresponds to geographical area #1 at a first depicted point in time, 10:00:00. However, the satellite's coverage area corresponds to geographical area #2 at 10:15:00 and geographical area #3 at 10:30:00.

A key issue has been discussed in 3GPP TR 23.737 and relates to regulatory services provided by a super-national satellite ground station. Specifically, the telecommunication regulations of the country in which the UE is physically located can be expected to be applicable to that UE's telecommunications operator. Some relaxations in regulations may be unavoidable, but the fewer relaxations that need to be negotiated, the better for speedy deployment.

System complexities can be expected when a satellite's coverage crosses country borders and/or the UE's communications use terrestrial equipment (e.g. Earth stations) that are in a different country to the UE. FIG. 5 illustrates a satellite coverage area that includes beams overlapping with several countries. In the depicted example, the UE is in Country B but the satellite coverage covers Country A, Country B, and Country C. A satellite system earth station (i.e., gNB) is located in each respective country.

Typically, the UE uses some positioning technique (e.g. Global Positioning System (GPS), Galileo, or some other GNSS) to determine its position. The UE and the network also have ephemeris data which describes the satellite orbit. That is, satellite movement in large scale is predictable and planned. However, there are problems with these existing solutions. For example, since most satellites are not stationary, the network devices need awareness of what kind of communication is allowed at what time. As different countries have different regulations for allowing satellite-based communication for devices, simply using any available satellite connectivity is not a feasible solution.

### SUMMARY

Certain aspects of the disclosure and their embodiments may provide solutions to these or other challenges. For example, methods and systems are provided use knowledge relating to UE location and/or satellite (gNB/cell) location with respect to a country to provide regulatory-aware access on an application level based on applicable regulations of the country associated with the UE's location.

According to certain embodiments, a method is provided by a LwM2M server for providing regulatory aware access to at least one network resource. The method includes obtaining information associated with a wireless device. The information includes a location of the wireless device. The LwM2M server transmits an object to at least one device for determining whether to allow the wireless device to access the network resource. The object includes the information comprising the location of the wireless device and at least one location-specific policy restriction associated with a satellite serving the location of the wireless device.

According to certain embodiments, a LwM2M server is provided for providing regulatory aware access to at least one network resource. The LwM2M server is adapted to obtain information associated with a wireless device. The information includes a location of the wireless device. The LwM2M server is adapted to transmit an object to at least one device for determining whether to allow the wireless device to access the network resource. The object includes the information comprising the location of the wireless device and at least one location-specific policy restriction associated with a satellite serving the location of the wireless device.

According to certain embodiments, a method by client device is provided for providing regulatory aware access to at least one network resource. The method includes receiving an object from a LwM2M server providing access to a client application. The object includes information comprising a location of a wireless device and at least one location-specific policy restriction associated with a satellite serving the location of the wireless device. The client device determines whether to allow the wireless device to access the at least one network resource based on at least one of the information comprising the location of the wireless device and the at least one location-specific policy restriction.

According to certain embodiments, a client device is provided for providing regulatory aware access to at least one network resource. The client device is adapted to receive an object from a LwM2M server providing access to a client application. The object includes information comprising a location of a wireless device and at least one location-specific policy restriction associated with a satellite serving the location of the wireless device. The client device is adapted to determine whether to allow the wireless device to access the at least one network resource based on at least one of the information comprising the location of the wireless device and the at least one location-specific policy restriction.

According to certain embodiments, a method by wireless device is provided for regulatory aware of at least one network resource. The method includes receiving an object from a LwM2M server providing access to the at least one network resource. The object includes information comprising a location of a wireless device and at least one location-specific policy restriction associated with a satellite serving the location of the wireless device. The wireless device determines whether to access the at least one network resource based on at least one of the information comprising the location of the wireless device and the at least one location-specific policy restriction.

According to certain embodiments, a wireless device is provided for regulatory aware of at least one network resource. The wireless device is adapted to receive an object from a LwM2M server providing access to the at least one network resource. The object includes information comprising a location of a wireless device and at least one location-specific policy restriction associated with a satellite serving the location of the wireless device. The wireless device is adapted to determine whether to access the at least one network resource based on at least one of the information comprising the location of the wireless device and the at least one location-specific policy restriction.

Certain embodiments may provide one or more of the following technical advantage(s). For example, certain embodiments may provide a technical advantage of enhancing L2M2M management protocol to provide the ability to configure communication rights at the application resource level based on the applicable communication satellite and regulation. As another example, certain embodiments may provide a technical advantage of updating the applications on a satellite with knowledge of UE locations to give the satellite the possibility to control the resources tha the UE can reach via the satellite.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a NG-RAN architecture:

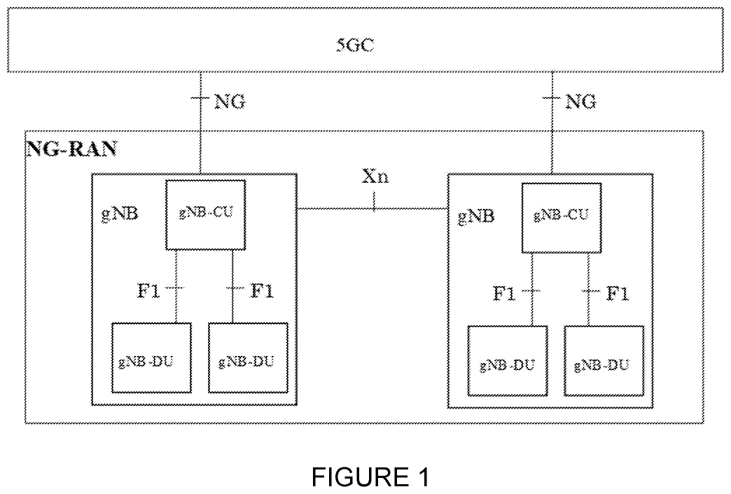

FIG. 2 illustrates a typical scenario of a non-terrestrial network providing access to a UE;

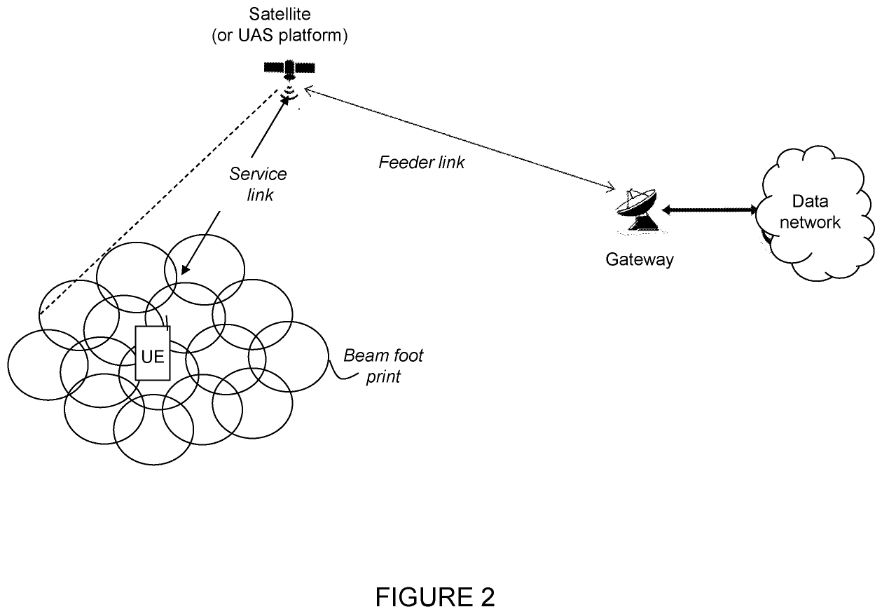

FIGS. 3A-3C illustrate a few example configurations of non-terrestrial networks;

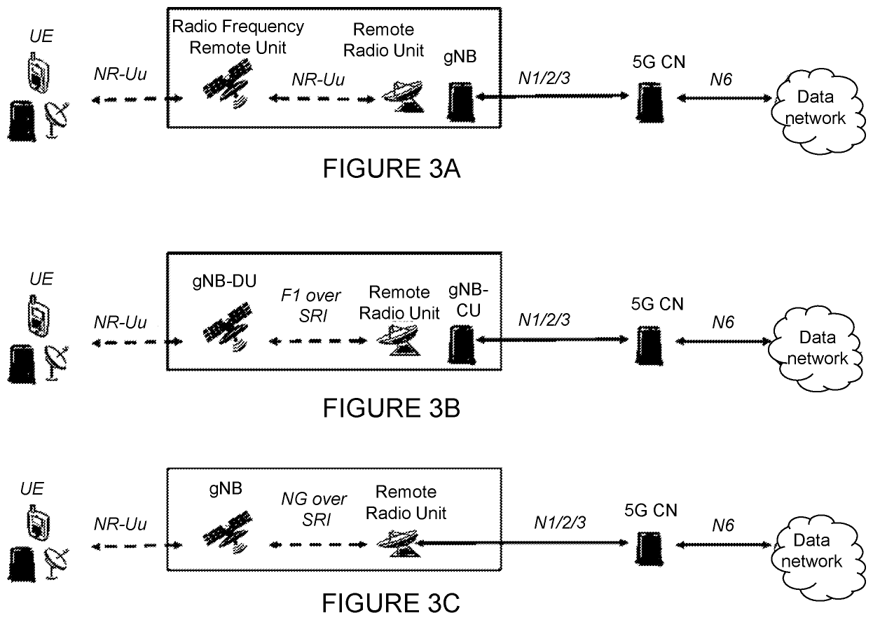

FIG. 4 illustrates a satellite as it sweeps across the earth over a sample of time;

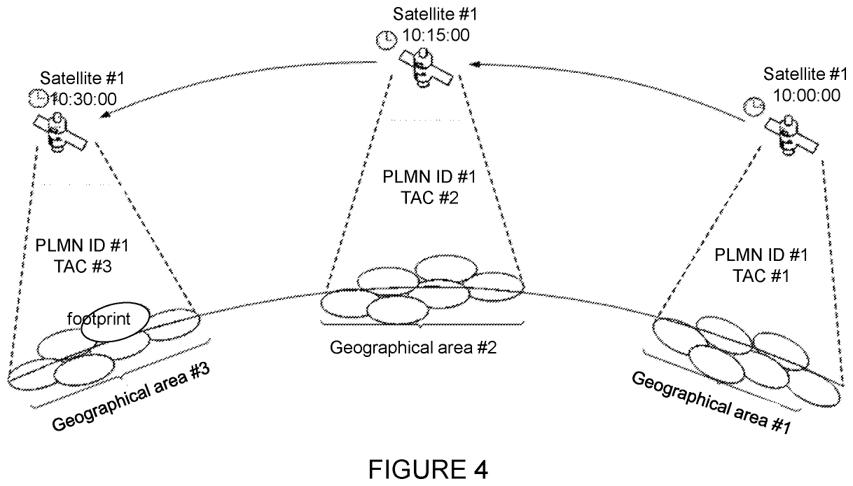

FIG. 5 illustrates a satellite coverage area that includes beams overlapping with several countries;

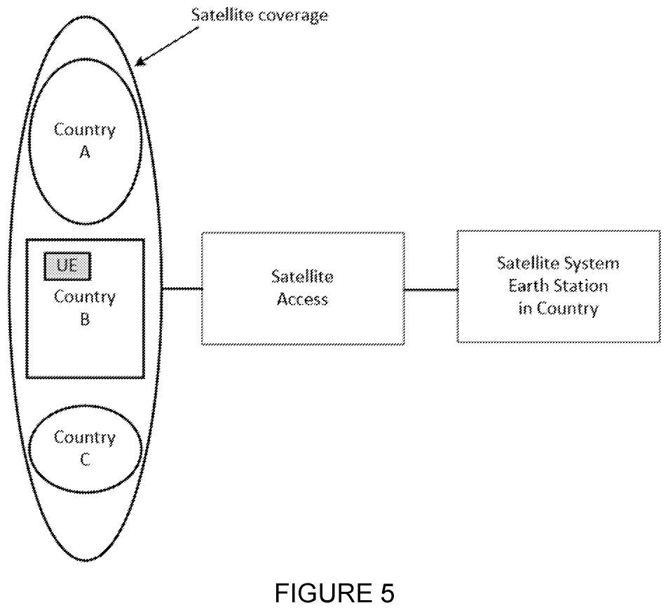

FIG. 6 illustrates signaling for updating information between a UE, a LwM2M server, and a client device, according to certain embodiments;

FIG. 7 illustrates an example communication system, according to certain embodiments;

FIG. 8 illustrates an example UE, according to certain embodiments;

FIG. 9 illustrates an example network node, according to certain embodiments;

FIG. 10 illustrates a virtualization environment in which functions implemented by some embodiments may be virtualized, according to certain embodiments;

FIG. 11 illustrates a method by a LwM2M server for providing regulatory aware access to at least one network resource, according to certain embodiments;

FIG. 12 illustrates a method by client device for providing regulatory aware access to at least one network resource; and

FIG. 13 illustrates a method by wireless device for regulatory aware of at least one network resource, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two: in general, “gNodeB” could be considered as device 1 and “UE” could be considered as device 2 and these two devices communicate with each other over some radio channel. And in the following the transmitter or receiver could be either gNB, or UE.

Certain embodiments described herein enhance the Lightweight Machine-to-Machine (LwM2M) management protocol to provide capability to configure communication rights at the application resource level based on the applicable communication satellite and regulation. According to certain embodiments, for example, a configuration entity takes satellite movement and timing information and combines that with application resource and regulatory knowledge to make a resource-level communication schedule for the LwM2M client. More specifically, certain embodiments use an application level protocol to indicate whether, based on the regulations of the country in which the UE, it is ok to communicate with the UE and which data elements are allowed. That is, as regulations may deny some services in some countries, and as satellites traverse around the globe, certain embodiments provided herein allow the operator to be global and provide regulatory-aware access to network resources.

With regard to providing satellite location information to the application, a satellite generally knows its location relative to ground and country borders as the movement of the satellite is described by satellite ephemeris data. This information is also known by the network nodes and by the operator.

Determining the UE location can be trivial if the information that the UE sends is deemed trustworthy. This is discussed in more detail below. However, it may be understood that UE location information is often not reliable such as when a UE is inside a country that has restricted the allowed traffic to/from a UE. In this case, the UE may provide false location to the gNB and or satellite so that it can communicate more freely. However, the case where UE location is not trustworthy is outside the scope of certain embodiments described herein. With respect to at least these embodiments, the solutions, methods and techniques described herein generally assume that the UE location information is trustworthy. Regardless, we can categorize the invention in two different cases: one where only the satellite location is known and one where both UE location and satellite location is known.

### Only Satellite Location Known

With this assumption, when the satellite beam is within a country, it can be assumed that application level directly follows the rules of that country.

When the satellite beam is moving from one country to another country, there are options that can take place. First option is that UE has selected correct Public Land Mobile Network (PLMN). If RAN sharing is applied, the same cell (satellite beam) can be used by both countries PLMN.

In RAN sharing, the system information of one cell broadcasts information of more than one PLMN. RAN sharing is a concept of terrestrial NR networks and includes where network elements are shared across two PLMNs. Each PLMN may be associated with a different country.

Other options exist. For example, according to a second option, as long as the satellite serves the country that has stricter regulations, all traffic via that satellite is restricted according to the stricter country's regulations. As another example, according to a third option, data is categorized such that data/service belonging to stricter category follows the rules of more restricted country and other data is served regardless whether UE position is known or not. According to still another option, the UE position that took place while satellite beam was fully covering a country is applied throughout the time the satellite is still serving that country.

### Both UE and Satellite Location is Known

When satellite beam is within one country, the case is the same as that described where only satellite location is known. However, when a satellite beam moves from one country to another country, network devices must trust location information from the UE or use some method to verify the accuracy of the information.

According to certain embodiments described herein, it is assumed that the UE had selected the correct PLMN as if RAN sharing is applied. Thus, the same cell (satellite beam) can be used by both countries PLMN. As described above, in RAN sharing (which is a concept of terrestrial NR networks), the system information of one cell broadcasts information of more than one PLMN.

For applications, end-to-end encryption provides problems as the proxy at the satellite/gNB cannot be sure what application has generated the data. When using OSCORE, it is possible to use integrity protection only and transfer the data inside DTLS. In this case, the middlebox, where the DTLS connection is terminated can see the OSCORE integrity protected data, but cannot alter it. With this, the middlebox can make decisions based on the data in the packet.

Location Information Transfer from the UE to the LwM2M Server

When different satellites fly over a certain area where the UE is located and the UE makes handover between satellites, the application on the satellite that is handling the UE data will change. Thus, the location information of the UE needs to be transferred to the currently serving satellite/application. The UE is not aware of the application instance that is handling the data transmission, the information between the UE and the application(s) has to be transmitted via an LwM2M server.

According to certain embodiments, the UE registers to the LwM2M server using either the satellite connection that it has established or some other mechanism if available. The resources the UE has to register include (at least) the ones in the Location and Connectivity Monitoring object. The UE also registers other resources that the UE is willing to provide for other clients.

According to certain embodiments, the LwM2M server observes the registered resources available on the UE. Some example resources that may be available on the UE are provided in TABLE 2 below. In some countries, some or all of these or other resources may be considered restricted resources.

TABLE 2

| Object | Resource | Resource ID |
|---|---|---|
| Location | Latitude | 6/0/0 |
| | Longitude | 6/0/1 |
| | Timestamp | 6/0/5 |
| Connectivity | Radio Signal | 4/0/2 |
| Monitoring | Strength | |
| | Link Quality | 4/0/3 |
| Temperature | Sensor value | 5700 |

According to certain embodiments, additional or other information may be stored on the server. In particular embodiments, this information may include the location of the UE, the time when this location was determined by the UE, a Cell ID that the UE is using, a signal strength and quality that can be potentially used for determining the coming need for change in the satellite. The server knows also the approximate times when the UE can reach which satellites from the informed location.

According to certain embodiments, a new Location Object is stored by the LwM2M server. The Location Object includes information relating to country regulated resources. For example, the Location Object may contain the list of the restricted resources in some country such as depicted in Table 3.

TABLE 3

| UE | Loc | Time | Cell ID |
|---|---|---|---|
| UE1 | Lat1, Lonl | Loc update time | Current Cell ID |

Table 4 includes information relating to resources from an example Connectivity Monitoring object, which may be stored by the LwM2M server.

TABLE 4

| | Radio Signal | | Update time |
|---|---|---|---|
| UE | Strength | Link Quality | (connectivity) |
| UE1 | UE1 sign_str | UE1 quality | Time_of_last_update |

The Connectivity monitoring object may also include other potentially relevant information such as, for example, IP address, Access Point Name (APN), Serving Mobile Network Code (SNC), Serving Mobile Country Code (SMCC), Location Area Code (LAC), signal-to-noise ratio (SNR), that may be used for the purposes described herein. The connectivity monitoring information can be used to determine whether the UE should be handed over to another satellite.

Table 5 includes example information relating to a satellite that may be stored by the LwM2M server.

TABLE 5

| | Sat availability at UE loc | Current loc of satellite, |
|---|---|---|
| UE | (approx.) | covered by the cell *) |
| UE1 | Comm 1; 10.01.14-10.04.40 | Country X, Country Y |
| | Comm 2; 10.03.41-10.07.25 | Country Y |

Table 6 includes example resource restriction information that may be stored by the LwM2M server.

TABLE 6

| UE | Resources | Restricted in | Restricted times |
|---|---|---|---|
| UE1 | Res 1 | Country X | 10.01.15-10.02.30 |
| | Res 2 | | |

According to certain embodiments, the LwM2M server also has knowledge of the limitations of communications permitted inside certain countries. These may be determined by country-specific regulations and laws. According to certain embodiments, the LwM2M server maps the resources that of the UE1 to the list of restricted resources.

According to certain embodiments, when the UE updates information on the LwM2M server, the LwM2M server further notifies the client device and/or or the application on the satellite about the new location information.

Likewise, according to certain embodiments, the UE1 may be informed by the LwM2M server about the restricted resources with a new LwM2M message. This information contains the Resource name and limitation specification (e.g. to any other application, to applications residing inside the same country, . . . ) The UE is required to apply to the restrictions. However, if the UE comply with the restrictions, the satellite application and/or gNB may drop the connection, in particular embodiments.

### Accessing Resources

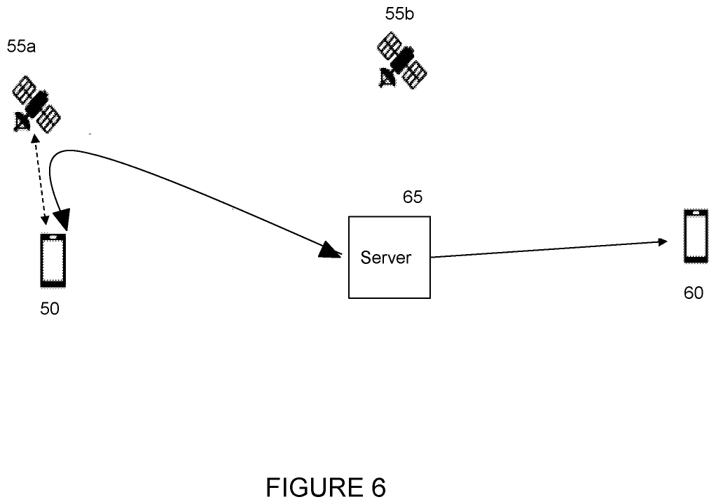

According to various embodiments described herein, applications that are external to the UE may use resources provided by the UE, and/or the UE may uses resources that are external to the UE via the Internet. FIG. 6 illustrates signaling for updating information between a UE, a LwM2M server, and a client device, according to certain embodiments.

For example, as depicted, a UE 50 is connected to a first satellite 55a. First, the UE 50 registers to the LwM2M server 65. Thus, the UE 50 may send, to the LwM2M server 65 a registration request. The UE 50 may also send, to the LwM2M server 65, location information indicating a current or previous location of the UE. When the UE 50 decides to access an external resource such as that provided, for example, by a client device 60, communications relating to the request for the external resource must pass through the satellite 55a to the LwM2M server 65.

The LwM2M server 65 then retrieves and/or obtains resource information and provides the resource information to the UE 50. The resource information indicates which resources the UE 50 can access via the Internet. Based on this information, the UE 50 can refrain from accessing some services that it knows already be unavailable for it. If there is no access to a fixed server, it may be recognized that the UE 50 must register itself to a new server/application each time it changes satellites. For example, if the UE 50 is handed over to a second satellite 55b, the UE 50) must register with the new satellite 55b and transmit new location information to the LwM2M server 65

Additionally or alternatively, client device 60 may access resources provided by a UE 50 via the Internet. According to certain embodiments, when a client device 60 tries to access resources on the UE 50 via the Internet, the LwM2M server 65 may inform the requesting client device 60 about the restrictions that may apply due to the location of the UE 50. The client device 65 also should obey the restriction information. However, if the client device 65 still tries to access the resources, the connection can be dropped by the satellite 55a or a gNB when, based on the location of the UE 50, the UE 50 is not allowed to transfer of certain information.

According to certain embodiments, the satellite 55a may also store location information associated with the UE and/or satellite cell coverage information. The satellite 55a may use some or all of this information to determine whether to allow the UE to access such information. Typically, the accessed information can be determined by inspecting the traffic, but if it is not possible to identify the traffic due to encryption of traffic, all traffic from that UE may be dropped. On the other hand, the UE may use OSCORE for integrity protection only (end-to-end) and DTLS between the UE and the middlebox that can decrypt the traffic and check from the OSCORE protected content the used protocols and accessed services.

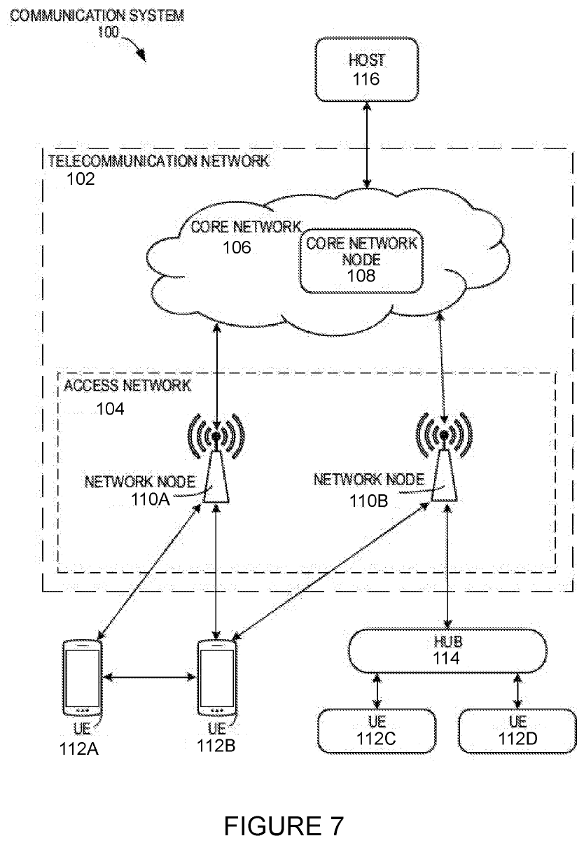

FIG. 7 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax). Bluetooth. Z-Wave. Near Field Communication (NFC) ZigBee. LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi. NR (New Radio) and LTE. i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios. UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

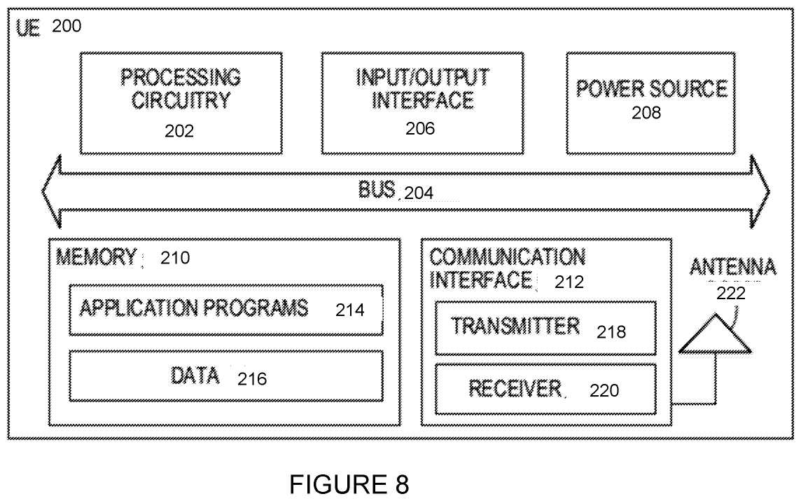

FIG. 8 shows a UE 200 in accordance with some embodiments. As used herein, a UE refers to a device capable, configured, arranged and/or operable to communicate wirelessly with network nodes and/or other UEs, Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as SIM card.” The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

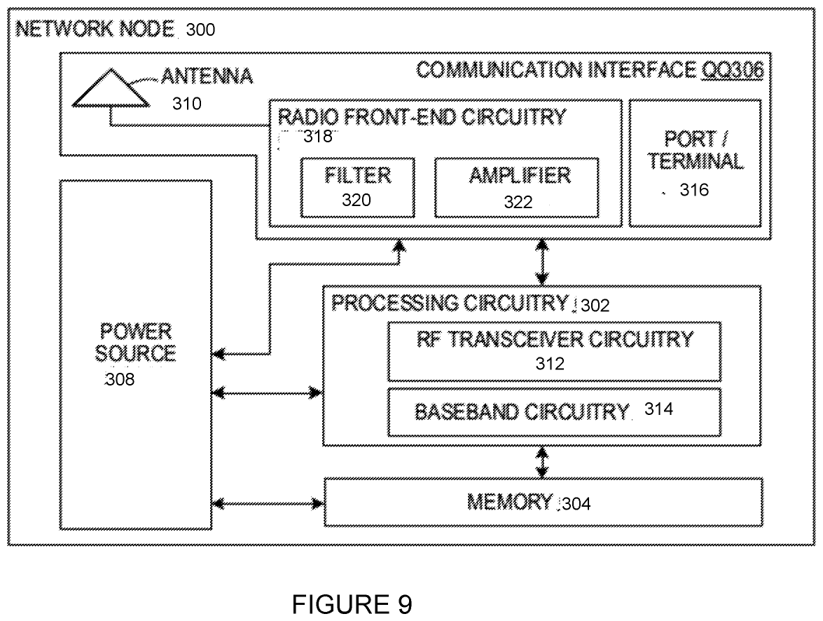

FIG. 9 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations. Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes. Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310) may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 9 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

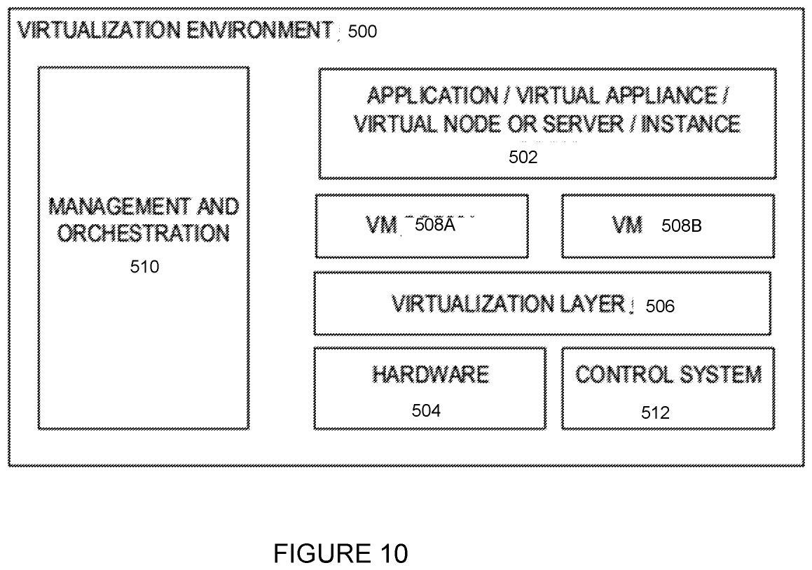

FIG. 10 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g, such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

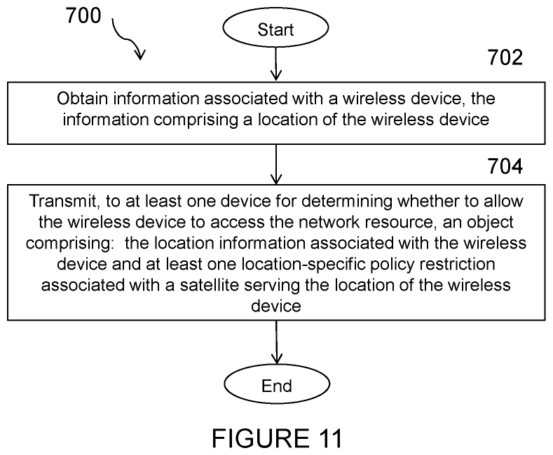

FIG. 11 illustrates a method 700 by a LwM2M server 65 for providing regulatory aware access to at least one network resource, according to certain embodiments. The method begins at step 702 when the LwM2M server 65 obtains information associated with a wireless device 50. The information includes a location of the wireless device. At step 704, the L2M2M server 65 transmits an object to at least one device 55a, 55b, 60, 50 for determining whether to allow the wireless device to access the network resource. The object includes the information comprising the location of the wireless device and at least one location-specific policy restriction associated with a satellite 55a serving the location of the wireless device 50.

In a particular embodiment, the LwM2M server 65 determines the at least one location-specific policy restriction associated with the location of the wireless device.

In a particular embodiment, the location-specific policy restriction is associated with at least one law and/or restriction of a country.

In a particular embodiment, the LwM2M server 65 obtains information about a coverage area of the satellite, and the at least one location-specific policy restriction is associated with the coverage area of the satellite.

In a further particular embodiment, the coverage area of the satellite at least partially overlaps with at least one geographical region associated with at least one country, and the LwM2M server 65 determines the at least one location-specific policy restriction based on at least one regulation or law of the at least one country.

In a further particular embodiment, the coverage area of the satellite at least partially overlaps with a first geographical region associated with a first country and a second geographical region associated with a second country, and the LwM2M server 65 determines the at least one location-specific policy restriction based on a first regulation or law of the first country and a second regulation of law of the second country.

In a further particular embodiment, the at least one location-specific policy restriction is based on a stricter one of the first regulation or law of the first country and the second regulation or law of the second country.

In a particular embodiment, the coverage area of the satellite at least partially overlaps with a first geographical region associated with a first country and a second geographical region associated with a second country, and the LwM2M server 65 determines that the wireless device has moved from the first country to the second country. The LwM2M server 65 determines the at least one location-specific policy restriction based on a regulation or law of the second country.

In a particular embodiment, the information comprising the location of the wireless device indicates that the wireless device has moved from the first country to the second country.

In a particular embodiment, the object is associated with a plurality of network resources provided by a client device, and each of the plurality of network resources being associated with a respective one of a plurality of identifiers.

In a particular embodiment, the object is transmitted to the wireless device for determining, by the wireless device, whether to access at least one network resource provided by the client device.

In a particular embodiment, the object is transmitted to a network node performing traffic control for determining, by the network node, whether to allow the wireless device to access at least one network resource provided by the client device.

In a particular embodiment, the object is transmitted to a client device for determining, by the client device, whether to allow the wireless device to access the at least one network resource provided by the client device.

In a particular embodiment, the location of the wireless device is associated with a handover of the wireless device from a first cell to a second cell.

In a particular embodiment, the information further includes at least one of: a time when the location of the wireless device was determined; an identifier of a cell in which the wireless device is being served: a signal strength of a cell in which the wireless device is being served; and a signal quality of a cell in which the wireless device is being served.

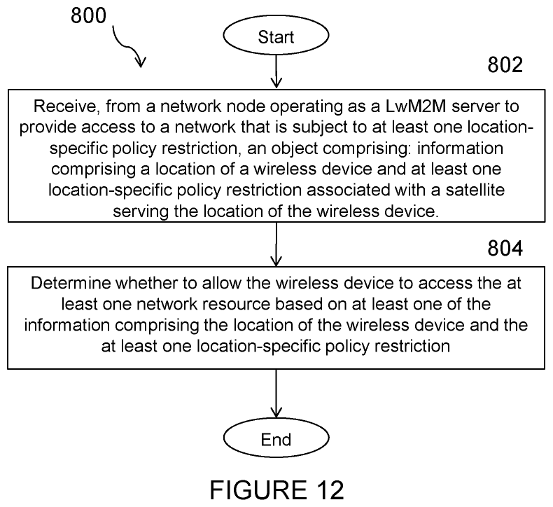

FIG. 12 illustrates a method 800 by client device 60 for providing regulatory aware access to at least one network resource, according to certain embodiments. The method begins at step 802 when the client device 60 receives an object from a LwM2M server providing access to a client application. The object includes information comprising a location of a wireless device and at least one location-specific policy restriction associated with a satellite serving the location of the wireless device. At step 804, the client device 60 determines whether to allow the wireless device to access the at least one network resource based on at least one of the information comprising the location of the wireless device and the at least one location-specific policy restriction.

In a particular embodiment, the location-specific policy restriction is associated with at least one law and/or restriction of a country.

In a particular embodiment, the client device obtains information associated with a coverage area of the satellite, and the at least one location-specific policy restriction is associated with the coverage area of the satellite.

In a particular embodiment, the coverage area of the satellite at least partially overlaps with at least one geographical region associated with at least one country, and the at least one location-specific policy restriction is associated with at least one regulation or law of the at least one country.

In a further particular embodiment, the coverage area of the satellite at least partially overlaps with a first geographical region associated with a first country and a second geographical region associated with a second country.

In a further particular embodiment, the at least one location-specific policy restriction is based on a stricter one of a first regulation or law of the first country and a second regulation or law of the second country.

In a further particular embodiment, the information indicates that the wireless device has moved from the first country to the second country, and the at least one location-specific policy restriction is based on a regulation or law of the second country.

In a particular embodiment, the object is associated with a plurality of network resources provided by the client device, and each of the plurality of resources is associated with a respective one of a plurality of identifiers.

In a particular embodiment, the location of the wireless device is associated with a handover of the wireless device from a first cell to a second cell.

In a particular embodiment, the object further includes information associated with at least one of: a time when the location of the wireless device was determined: an identifier of a cell in which the wireless device is being served: a signal strength of a cell in which the wireless device is being served; and a signal quality of a cell in which the wireless device is being served.

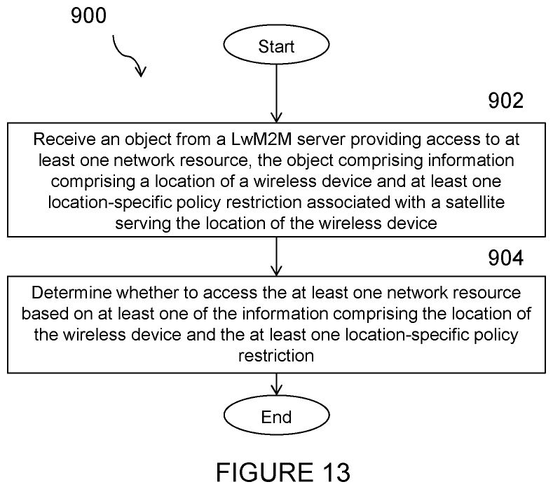

FIG. 13 illustrates a method 900 by wireless device 50 for regulatory aware of at least one network resource, according to certain embodiments. The method begins at step 902 when the wireless device 50 receives an object from a LwM2M server 65 providing access to the at least one network resource. The object includes information comprising a location of a wireless device and at least one location-specific policy restriction associated with a satellite 55a serving the location of the wireless device. The wireless device 50 determines whether to access the at least one network resource based on at least one of the information that includes the location of the wireless device and the at least one location-specific policy restriction.

In a particular embodiment, prior to receiving the object, the wireless device 50 determines the location of the wireless device 50 and transmits the information comprising the location of the wireless device to at least one network device.

In a particular embodiment, the information transmitted to the at least one network device further includes at least one of: a time when the location of the wireless device was determined: an identifier of a cell in which the wireless device is being served: a signal strength of a cell in which the wireless device is being served; and a signal quality of a cell in which the wireless device is being served.

In a further particular embodiment, the information is transmitted to the LwM2M server.

In a particular embodiment, the location-specific policy restriction is associated with at least one law and/or restriction of a country.

In a particular embodiment, the at least one location-specific policy restriction is associated with a coverage area of the satellite.

In a further particular embodiment, the coverage area of the satellite at least partially overlaps with at least one geographical region associated with at least one country and the at least one location-specific policy restriction is associated with at least one regulation or law of the at least one country.

In a particular embodiment, the coverage area of the satellite at least partially overlaps with a first geographical region associated with a first country and a second geographical region associated with a second country.

In a particular embodiment, the at least one location-specific policy restriction is based on a stricter one of a first regulation or law of the first country and a second regulation or law of the second country.

In a particular embodiment, the information comprising the location of the wireless device indicates that the wireless device has moved from the first country to the second country and the at least one location-specific policy restriction is based on a regulation or law of the second country.

In a particular embodiment, the object is associated with a plurality of network resources provided by the client device, and each of the plurality of network resources is associated with a respective one of a plurality of identifiers.

In a particular embodiment, the location of the wireless device is associated with a handover of the wireless device from a first cell to a second cell.

In a particular embodiment, the object further comprises information associated with at least one of: a time when the location of the wireless device was determined: an identifier of a cell in which the wireless device is being served: a signal strength of a cell in which the wireless device is being served; and a signal quality of a cell in which the wireless device is being served.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a Lightweight Machine to Machine (LwM2M) server for providing regulatory aware access to at least one network resource, the method comprising:
obtaining information associated with a wireless device, the information comprising a location of the wireless device;
transmitting, to at least one device for determining whether to allow the wireless device to access the network resource, an object comprising:
the information comprising the location of the wireless device, and
at least one location-specific policy restriction associated with a satellite serving the location of the wireless device.

2. The method of claim 1, further comprising determining the at least one location-specific policy restriction associated with the location of the wireless device.

3. The method of claim 1, wherein the location-specific policy restriction is associated with at least one law and/or restriction of a country.

4. The method of claim 1, further comprising obtaining information about a coverage area of the satellite, wherein the at least one location-specific policy restriction is associated with the coverage area of the satellite.

5. The method of claim 4, wherein the coverage area of the satellite at least partially overlaps with at least one geographical region associated with at least one country, and the method further comprises:
determining the at least one location-specific policy restriction based on at least one regulation or law of the at least one country.

6. The method of claim 4, wherein the coverage area of the satellite at least partially overlaps with a first geographical region associated with a first country and a second geographical region associated with a second country, and the method further comprises:
determining the at least one location-specific policy restriction based on a first regulation or law of the first country and a second regulation of law of the second country.

7. The method of claim 6, wherein the at least one location-specific policy restriction is based on a stricter one of the first regulation or law of the first country and the second regulation or law of the second country.

8. The method of claim 4, wherein the coverage area of the satellite at least partially overlaps with a first geographical region associated with a first country and a second geographical region associated with a second country, and the method further comprises:
determining that the wireless device has moved from the first country to the second country; and
determining the at least one location-specific policy restriction based on a regulation or law of the second country.

9. The method of claim 10, wherein the information comprising the location of the wireless device indicates that the wireless device has moved from the first country to the second country.

10. The method of claim 1, wherein the object is associated with a plurality of network resources provided by a client device, each of the plurality of network resources being associated with a respective one of a plurality of identifiers.

11. The method of claim 10, wherein transmitting the object to the at least one device comprises transmitting the object to the wireless device for determining, by the wireless device, whether to access at least one network resource provided by the client device.

12. The method of claim 10, wherein transmitting the object to the at least one device comprises transmitting the object to a network node performing traffic control for determining, by the network node, whether to allow the wireless device to access at least one network resource provided by the client device.

13. The method of claim 10, wherein transmitting the object to the at least one device comprises transmitting the object to the client device for determining, by the client device, whether to allow the wireless device to access the at least one network resource provided by the client device.

14. The method of claim 1, wherein the location of the wireless device is associated with a handover of the wireless device from a first cell to a second cell.

15. The method of claim 1, wherein the information further comprises at least one of:
a time when the location of the wireless device was determined;
an identifier of a cell in which the wireless device is being served;
a signal strength of a cell in which the wireless device is being served; and
a signal quality of a cell in which the wireless device is being served.

16. A method by client device for providing regulatory aware access to at least one network resource, the method comprising:
receiving an object from a Lightweight Machine to Machine (LwM2M); server providing access to a client application, the object comprising:
information comprising a location of a wireless device, and
at least one location-specific policy restriction associated with a satellite serving the location of the wireless device; and
determining whether to allow the wireless device to access the at least one network resource based on at least one of the information comprising the location of the wireless device and the at least one location-specific policy restriction.

17. The method of claim 16, wherein the location-specific policy restriction is associated with at least one law and/or restriction of a country.

18. The method of claim 16, further comprising obtaining information associated with a coverage area of the satellite, wherein the at least one location-specific policy restriction is associated with the coverage area of the satellite.

19. The method of claim 18, wherein:
the coverage area of the satellite at least partially overlaps with at least one geographical region associated with at least one country, and
the at least one location-specific policy restriction is associated with at least one regulation or law of the at least one country.

20-25. (canceled)

26. A method by wireless device for regulatory aware of at least one network resource, the method comprising:
receiving an object from a Lightweight Machine to Machine (LwM2M); server providing access to the at least one network resource, the object comprising:
information comprising a location of a wireless device, and
at least one location-specific policy restriction associated with a satellite serving the location of the wireless device; and
determining whether to access the at least one network resource based on at least one of the information comprising the location of the wireless device and the at least one location-specific policy restriction.

27-76. (canceled)
